(19) United States
(12) Patent Application Publication
(10) Pub. No.: US 2026/0229217 A1
(43) Pub. Date: Aug. 6, 2026

(54) METHOD AND SYSTEM FOR SPEECH PROTECTION, AND TRAINING METHOD FOR SPEECH PROTECTION MODEL

(71) Applicant: National Tsing Hua University, Hsinchu (TW)

(72) Inventors: CHI-CHUN LEE, Hsinchu (TW); CHING-YU YANG, Hsinchu (TW)

(21) Appl. No.: 19/206,775

(22) Filed: May 13, 2025

(30) Foreign Application Priority Data
Feb. 5, 2025 (TW) 114104176

(51) Int. Cl. G10L 13/033; G10L 25/24

(52) U.S. Cl. CPC G10L 13/033; G10L 25/24

(57) ABSTRACT

A method for training a speech protection model is provided. The method includes: selecting a first speech and a second speech from a speech database; extracting multiple first features from the first speech; extracting multiple second features from the second speech; generating a first mixed speech based on the first speech, multiple first features, and multiple second features using the speech protection model; extracting multiple third features from the first mixed speech; calculating a first distance between multiple third features and multiple first features and a second distance between multiple third features and multiple second features; calculating a loss function based on the first distance and the second distance; and updating the speech protection model based on the loss function. The loss function is positively correlated with the first distance and is negatively correlated with the second distance.

### CROSS-REFERENCE TO RELATED APPLICATION(S)

The present disclosure claims the benefit of and priority to Taiwan Patent Application No. 114,104,176, filed on Feb. 5, 2025, the contents of which are hereby fully incorporated herein by reference for all purposes.

### FIELD

The present disclosure is generally related to a speech processing technology, and more specifically, to a method and system for speech protection, and a method for training a speech protection model.

### BACKGROUND

With the advancement of deep learning technology, voice conversion technology has developed to the extent that it can replicate a speaker's voice characteristics with just a single sentence. This technology can change the identity features of the speaker while maintaining the content of the speech and is used for positive purposes, such as AI dubbing and cross-language voice conversion. However, this technology also poses serious security risks. There have been reports of criminals using voice conversion technology for telephone scams, thus resulting in significant economic losses.

Existing solutions mainly focus on deep fake audio detection, which attempts to differentiate between real and synthesized voices. However, these methods can only passively detect voices that have already been copied and are unable to prevent voice theft, thus presenting room for improvements. As voice conversion technology continues to advance, the effectiveness of detection methods also faces challenges.

### SUMMARY

In view of the above, the present disclosure provides a method and system for speech protection and a method for training a speech protection model that may effectively prevent voices from being replicated by voice conversion models, while maintaining the characteristics of the speaker's original voice. Advantageously, this protective mechanism maintains the comprehensibility of the voice to human listeners while protecting the voice from being copied.

A first aspect of the present disclosure provides a method for training a speech protection model that is applicable to a system including a speech database. The method includes: selecting a first speech and a second speech from the speech database; extracting multiple first features from the first speech; extracting multiple second features from the second speech; generating a first mixed speech based on the first speech, multiple first features, and multiple second features using the speech protection model; extracting multiple third features from the first mixed speech; calculating a first distance between multiple third features and multiple first features and a second distance between multiple third features and multiple second features; calculating a loss function based on the first distance and the second distance; and updating the speech protection model based on the loss function. The loss function is positively correlated with the first distance and is negatively correlated with the second distance.

In some implementations of the first aspect, generating the first mixed speech based on the first speech, multiple first features, and multiple second features using the speech protection model includes: inputting the first speech, multiple first features, and multiple second features into the speech protection model to generate an initial noise; and adding the initial noise to the first speech to obtain the first mixed speech.

In some implementations of the first aspect, adding the initial noise to the first speech to obtain the first mixed speech includes: performing an offset removal operation on the initial noise to obtain an adjusted noise; and adding the adjusted noise to the first speech based on a first signal-to-noise ratio to obtain the first mixed speech.

In some implementations of the first aspect, the first speech and the second speech are from different speakers.

In some implementations of the first aspect, the first speech is a time-domain signal, and extracting multiple first features from the first speech includes: converting the first speech into a Mel-spectrogram; and extracting multiple first features from the Mel-spectrogram.

A second aspect of the present disclosure provides a computer-implemented method for speech protection. The method includes: receiving an input speech; generating a protective noise based on the input speech and a speech protection model; and adding the protective noise to the input speech to obtain a protected speech. The speech protection model is trained by: selecting a first speech and a second speech from a speech database; extracting multiple first features from the first speech; extracting multiple second features from the second speech; generating a first mixed speech based on the first speech, multiple first features, and multiple second features using the speech protection model; extracting multiple third features from the first mixed speech; calculating a first distance between multiple third features and multiple first features and a second distance between multiple third features and multiple second features; calculating a loss function based on the first distance and the second distance; and updating the speech protection model based on the loss function. The loss function is positively correlated with the first distance and is negatively correlated with the second distance.

In some implementations of the second aspect, generating the first mixed speech based on the first speech, multiple first features, and multiple second features using the speech protection model includes: inputting the first speech, multiple first features, and multiple second features into the speech protection model to generate an initial noise; and adding the initial noise to the first speech to obtain the first mixed speech.

In some implementations of the second aspect, adding the initial noise to the first speech to obtain the first mixed speech includes: performing an offset removal operation on the initial noise to obtain an adjusted noise; and adding the adjusted noise to the first speech based on a first signal-to-noise ratio to obtain the first mixed speech.

In some implementations of the second aspect, the first speech is a time-domain signal, and extracting multiple first features from the first speech includes: converting the first speech into a Mel-spectrogram; and extracting multiple first features from the Mel-spectrogram.

A third aspect of the present disclosure provides a speech protection system including: an input component configured to receive an input speech; a memory configured to store at least one instruction; and a processor coupled to the input component and the memory. When the processor executes the at least one instruction, the processor is configured to: generate a protective noise based on the input speech and a speech protection model; and adding the protective noise to the input speech to obtain a protected speech. The speech protection model is trained by: selecting a first speech and a second speech from a speech database; extracting multiple first features from the first speech; extracting multiple second features from the second speech; generating a first mixed speech based on the first speech, multiple first features, and multiple second features using the speech protection model; extracting multiple third features from the first mixed speech; calculating a first distance between multiple third features and multiple first features and a second distance between multiple third features and multiple second features; calculating a loss function based on the first distance and the second distance; and updating the speech protection model based on the loss function. The loss function is positively correlated with the first distance and is negatively correlated with the second distance.

### BRIEF DESCRIPTION OF THE DRAWINGS

FIG. 1 is a diagram of a method for training a speech protection model in accordance with an example implementation of the present disclosure.

FIG. 2 is a flowchart of a method for training a speech protection model in accordance with an example implementation of the present disclosure.

FIG. 3 is a diagram of a speech protection model in accordance with an example implementation of the present disclosure.

FIG. 4 is a flowchart of a speech protection model in accordance with an example implementation of the present disclosure.

FIG. 5 is a block diagram of a computing system in accordance with an example implementation of the present disclosure.

### DESCRIPTION

The following will refer to the relevant drawings to describe implementations of a training method and implementation system for speech protection model in the present disclosure, in which the same components will be identified by the same reference symbols.

The following description includes specific information regarding the exemplary implementations of the present disclosure. The accompanying detailed description and drawings of the present disclosure are intended to illustrate the exemplary implementations only. However, the present disclosure is not limited to these exemplary implementations. Those skilled in the art will appreciate that various modifications and alternative implementations of the present disclosure are possible. In addition, the drawings and examples in the present disclosure are generally not drawn to scale and do not correspond to actual relative sizes.

For consistency and ease of understanding, the same features are denoted by numerals in the exemplary drawings (although not always marked as such in some examples). However, features in different implementations may differ in other respects, and should not be narrowly confined to the features shown in the drawings.

Terms such as “at least one implementation,” “one implementation,” “various implementations,” “different implementations,” “some implementations,” “this implementation,” may indicate that the implementation(s) described as such may include specific features, structures, or characteristics, but not all possible implementations of the present disclosure need to include these specific features, structures, or characteristics. Moreover, the repeated use of the phrases “in one implementation,” “in this implementation” does not necessarily refer to the same implementation, although they may be. Furthermore, phrases like “implementation” used in conjunction with “the present disclosure” do not imply that all implementations must include specific features, structures, or characteristics, and should be understood to mean “at least some implementations of the present disclosure” include the specified features, structures, or characteristics. The term “coupled” is defined as a connection, whether direct or indirect, through an intermediate component, and is not necessarily limited to a physical connection. When the terms “comprising” or “including” are used, they mean “including but not limited to,” and explicitly indicate an open relationship between the combination, group, series, and the like.

Additionally, for the purpose of explanation and non-limitation, specific details such as functional entities, techniques, protocols, standards, etc., are set forth to provide an understanding of the described technology. In other examples, detailed descriptions of well-known methods, techniques, systems, architectures, etc., have been omitted to avoid unnecessarily obscuring the described implementations.

The terms “first,” “second,” and “third” and the like are used to distinguish different objects, not to describe a specific order. Furthermore, the terms “comprising” and any variations thereof are intended to cover non-exclusive inclusion. For example, a process, method, system, product, or device that includes a series of actions or modules is not limited to the listed actions or modules, but may optionally include unlisted actions or modules, or other actions or modules inherent to these processes, methods, products, or devices.

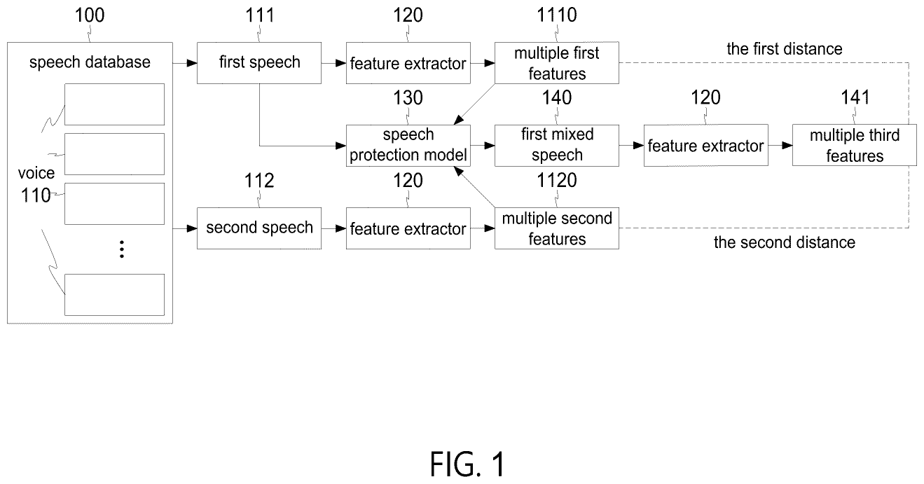

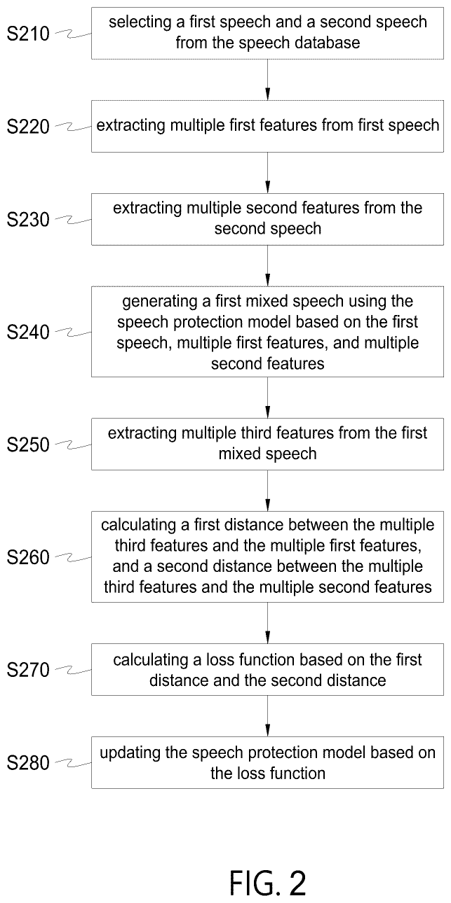

FIG. 1 is a diagram of a method for training a speech protection model in accordance with an example implementation of the present disclosure. FIG. 2 is a flowchart of a method for training a speech protection model in accordance with an example implementation of the present disclosure.

Referring to FIG. 1 and FIG. 2, the system for training the speech protection model 130 includes a speech database 100 storing multiple voices 110; a feature extractor 120; and the speech protection model 130. For clarity of description, a first voice 111 and a second voice 112, among many voices 110 in the speech database 100, are marked. However, it should be noted that the first voice 111 and the second voice 112 are merely representative examples used to illustrate embodiments of the disclosure and are functionally no different from other voices 110. The method for training the speech protection model that is proposed by embodiments of the disclosure applies to a system architecture containing at least two voices.

In action S210, the system initially selects the first speech 111 and the second speech 112 from the speech database 100. The speeches here refer to time-domain signals recorded in a waveform format, for example, PCM format voice files with a sampling rate of 16 kHz, but the present disclosure is not limited thereto. In some implementations, the first speech 111 and the second speech 112 may come from different speakers, for example, the first speech 111 may come from a male speaker, while the second speech 112 may come from a female speaker. In some implementations, the system may choose appropriate voice samples based on the quality and length of the speeches. For example, the system may select voice samples with a higher signal-to-noise ratio and a longer duration to ensure the accuracy of subsequent feature extraction. Advantageously, this targeted selection strategy may improve training effectiveness.

In action S220, the system extracts multiple first features 1110 from first speech 111. Specifically, the system may use the feature extractor 120 to extract multiple first features 1110 from the first speech 111.

In some implementations, the system may first convert the first speech 111 into a time-frequency domain Mel-spectrogram, then use feature extractor 120 to extract multiple first features 1110 from the Mel-spectrogram. A Mel-spectrogram is a time-frequency domain representation based on human auditory perception, whose frequency distribution is suitable for capturing the characteristics of the speaker, including pitch, prosody, and timbre. Advantageously, this representation allows for an effective analysis of the impact of protective noise on these features.

In some implementations, the feature extractor 120 may include sub-modules, such as a voice conversion module and a speaker encoder. For example, the voice conversion module is responsible for converting the original speech into a Mel-spectrogram, and the speaker encoder extracts the speaker characteristics based on the Mel-spectrogram. The speaker encoder may be a pre-trained deep learning model, such as a Speaker Encoder.

In some implementations, these first features 1110 may include fundamental frequency features reflecting pitch variations of the speaker, spectral features containing timbre information of the speech, and prosodic features describing the rhythm and accent of the speech, among others, but the present disclosure is not limited thereto.

In some implementations, the feature extractor 120 may also extract acoustic features representing the identity characteristics of the speaker. Advantageously, multi-dimensional feature extraction may more comprehensively capture the characteristics of the speech.

In some implementations, the feature extractor 120 adopts a multi-layer neural network structure. Specifically, this structure includes multiple convolutional layers and pooling layers, configured to extract features at different levels from the Mel-spectrogram. For example, shallow networks primarily extract basic acoustic features, such as frequency distribution, while deep networks may capture more complex speaker characteristics, such as voice personalization features. Advantageously, this hierarchical feature extraction method may more comprehensively represent various aspects of the speech.

In action S230, the system extracts multiple second features 1120 from the second speech 112. The method for extracting multiple second features 1120 from second speech 112 in action S230 is the same as the method for extracting multiple first features 1110 from first speech 111 in action S220, which is not further elaborated here.

In some implementations, the feature extractor 120 configured to extract multiple second features 1120 may be the same as the feature extractor 120 configured to extract multiple first features 1110. Specifically, using the same feature extractor 120 ensures consistency in feature extraction, which aids subsequent feature comparison.

In some implementations, the feature extractor 120 configured to extract multiple second features 1120 may be different from the feature extractor 120 configured to extract multiple first features 1110 to obtain a more diverse set of feature information. For example, the feature extractor 120 processing the second speech 112 may focus more on the overall characteristics of the speech. The present disclosure is not limited to any specific configuration of feature extractor 120.

In some implementations, the feature extractor 120 is frozen during the training process of the speech protection model 130, meaning its parameters do not participate in updates. Since the feature extractor 120 primarily extracts speaker characteristics from the speech, keeping its parameters fixed ensures consistency in feature extraction. Advantageously, this design provides stable feature representations, aiding the training of the speech protection model 130.

In some implementations, the speech protection model 130 adopts an improved WaveUNet architecture. WaveUNet is an end-to-end deep neural network architecture that processes audio directly in the waveform domain, which is originally designed for audio source separation tasks. The present disclosure improves the WaveUNet architecture to make speech protection tasks more effective.

Specifically, the improved WaveUNet architecture introduces a conditional embedding mechanism, making the improved WaveUNet architecture a three-input architecture. Besides the original speech waveform input, two conditional inputs are added to the architecture: embedding vectors of first features 1110 and second features 1120. Specific improvements include: (1) introducing a new feature processing branch in the downsampling path, which first concatenates the first features 1110 and second features 1120; (2) passing the concatenated features through a linear layer for dimension transformation; (3) concatenating the transformed features with the output of the original WaveUNet downsampling layers; and (4) processing the concatenated result through a one-dimensional convolution layer, then linking the concatenated result back to the main backbone of the original WaveUNet. These improvements enable the model to simultaneously handle speech waveforms and speaker characteristics.

For example, in the downsampling path, the mixed audio is first processed through a one-dimensional convolution layer of size 15, followed by downsampling, and through multiple downsampling blocks (e.g., L blocks), gradually reducing the time resolution of the feature maps while increasing the number of channels, to extract more abstract features. In the upsampling path, corresponding L upsampling blocks gradually restore the time resolution using one-dimensional convolution layers of size 5. To preserve more detail information, the present disclosure incorporates multiple skip connections in the architecture, thus connecting the output of each downsampling block directly to the corresponding upsampling block through crop and concatenate. Advantageously, this architectural design not only preserves more detail information during the restoration of time resolution but also effectively utilizes speaker characteristics for noise generation.

Advantageously, using the improved WaveUNet architecture allows direct computation in the waveform domain, thus avoiding dimensional issues that might arise from feature extraction and voice synthesis stages. Furthermore, through the design of conditional embeddings, the model may self-adapt based on the input features, thus further enhancing processing effectiveness, combining time-domain operations with feature parameter adjustment mechanisms, and making the speech protection model 130 highly adaptable and flexible.

In action S240, the system generates a first mixed speech 140 using the speech protection model 130 based on the first speech 111, multiple first features 1110, and multiple second features 1120. Specifically, the speech protection model 130 generates an initial noise based on the input features, and the system then adds the initial noise to the first speech 111. In some implementations, the generation of the initial noise is regulated by the first features 1110 and second features 1120. For example, the system may adjust the spectral distribution and intensity of the noise based on these features to generate more targeted protective noise.

In some implementations, the inputs to the speech protection model 130 include the first speech 111, first features 1110, and second features 1120, while the output of the speech protection model 130 includes the initial noise.

In some implementations, the system performs an offset removal operation on the generated initial noise to adjust its mean to zero, resulting in adjusted noise. Subsequently, the system adds the adjusted noise to the first speech 111, based on a first Signal-to-Noise Ratio (SNR), to obtain the first mixed speech 140. The first SNR, for example, may be a preset SNR or specified by the user, but is not limited to the examples provided herein.

Advantageously, this processing increases the randomness of the noise, thus avoiding a fixed offset pattern in the noise. Moreover, when the initial noise with a mean adjusted to zero is added to the first speech 111, the initial noise with a mean adjusted to zero may more uniformly affect different frequency bands of the speech signal, which is beneficial for enhancing the masking effect on speech features and protection reliability. Specifically, the system mixes the adjusted noise with the first speech 111, based on the set SNR, to balance protection effectiveness and speech quality. For example, in scenarios requiring high speech quality, users may set a higher SNR, thus adding weaker noise to preserve the clarity and intelligibility of the first mixed speech 140. In scenarios requiring enhanced protection, users may choose a lower SNR, thus increasing the noise intensity to improve the masking effect on speech features. Advantageously, a flexible SNR adjustment mechanism allows the system to meet the protection needs of different users across various application scenarios.

In some implementations, the first SNR is, for example, preset at 20. Advantageously, this controlled noise generation mechanism may maintain the recognizability of the speech while protecting it.

In action S250, the system extracts multiple third features 141 from the first mixed speech 140. In some implementations, the feature extractor 120 that is configured to extract the third features 141 adopts the same configuration as the previous feature extraction to ensure consistency of features. Specifically, the first mixed speech 140 is, for example, a time-domain signal in the form of amplitude over time. The system may first convert the first mixed speech 140 into a Mel-spectrogram, then extract multiple third features 141 from the Mel-spectrogram.

Advantageously, the system operates directly on the original waveform through the speech protection model 130, thus avoiding domain mismatch issues, common in traditional methods that require multiple conversions between time-domain, frequency-domain features, and reconstruction of time-domain signals. In some implementations, the speech protection model 130 may directly generate protective noise 330 based on the input raw waveform and feature representations, thus providing parameterized control over noise intensity. Users may adjust the protection parameters according to actual needs, for example, increasing noise intensity for high protection demands or reducing the noise intensity to ensure clarity for scenarios requiring maintained speech quality.

In action S260, the system calculates a first distance between the multiple third features 141 and the multiple first features 1110 and a second distance between the multiple third features 141 and the multiple second features 1120. This action aims to quantify the differences between various features, where “distance” here refers to a mathematical measure of the difference between two sets of feature parameters.

Specifically, the first distance is configured to measure the similarity between the first mixed speech 140 and the first speech 111 (or between the third features 141 and the first features 1110), while the second distance is configured to assess the similarity between the first mixed speech 140 and the second speech 112 (or between the third features 141 and the second features 1120). That is, a smaller first distance indicates a high similarity in features between the first mixed speech 140 and the first speech 111, and a larger second distance indicates a low similarity in features between the first mixed speech 140 and the second speech 112.

In some implementations, various methods may be used to calculate distances or similarities between features. Specifically, Cosine Similarity may be used to calculate the similarity between feature vectors, or Euclidean Distance may be used to measure the differences between feature vectors. For example, when using Cosine Similarity, higher values indicate more similar features; when using Euclidean Distance, larger values indicate greater differences. Advantageously, this dual calculation design may simultaneously ensure the recognizability of the speech and its anti-copying effects.

In some implementations, the system employs an adjustable weight calculation mechanism to balance the impact of the first and second distances. Specifically, the system introduces a weight parameter λ (where λ is a positive real number) to calculate the first weighted value for the first distance and the second weighted value for the second distance. For example, when emphasizing the preservation of original speech features, the A value may be decreased to enhance the contribution of the first distance. When emphasizing the anti-copying effect, the λ value may be increased to enhance the contribution of the second distance. Advantageously, this adjustable weight mechanism allows the system to adjust the strength of protection according to different application needs, thus achieving a balance between speech clarity and protection effectiveness.

In action S270, the system calculates a loss function based on the first distance and the second distance. Specifically, the loss function is positively correlated with the first distance and negatively correlated with the second distance. In some implementations, the system adjusts the strengths of these correlations by setting different weighted values through the weight parameter λ. For example, to emphasize the preservation of the original speech's recognizability, the weight for the first distance may be increased. To emphasize the anti-copying effect, the weight for the second distance may be increased. In other implementations, these weight parameters may be dynamically adjusted during the training process. Advantageously, this flexible design of the loss function allows for adjustments to the protection effect based on specific needs.

In some implementations, the loss function (denoted as Lcs) may be calculated as follows:

$${L}_{C S} = 1 - cos ( {E}_{a d v} , {E}_{x} ) + λ \cdot max ( 0 , cos ( {E}_{a d v} , {E}_{y} ) )$$

where E_{adv} represents the feature embedding of the first mixed speech 140 (for example, the third features 141), Eₓ represents the feature embedding of the first speech 111 (for example, the first features 1110), E_{y} represents the feature embedding of the second speech 112 (for example, the second features 1120), cos represents cosine similarity, and λ is a weight parameter. Specifically, the first term 1−cos (E_{adv}, Eₓ) ensures the similarity between the first mixed speech 140 and the first speech 111, and the second term max(0, cos(E_{adv}, E_{y})) suppresses the similarity between the first mixed speech 140 and the second speech 112. In other words, E_{adv} is preferred to be as far from Eₓ as possible and as close to E_{y} as possible. Advantageously, using cosine similarity as the loss function not only provides high computational efficiency but also effectively measures the angular relationship between vectors, thus making it particularly suitable for distance measurement in feature embedding spaces.

In some implementations, the system may also use Mean Squared Error (MSE loss) as a distance metric, and the loss function (denoted as LMSE) may be calculated as follows:

$${L}_{M S E} = - MSE ( {E}_{a d v} , {E}_{x} ) + λ \cdot MSE ( {E}_{a d v} , {E}_{y} )$$

where MSE denotes the mean squared error function, which is configured to measure the squared Euclidean distance between two embedding vectors. The negative sign in the first term −MSE(E_{adv}, Eₓ) indicates the aim to maximize the distance between the first mixed speech 140 and the first speech 111, while the second term λ·MSE(E_{adv}, E_{y}) indicates the aim to minimize the distance between the first mixed speech 140 and the second speech 112. Advantageously, using MSE as the loss function directly reflects the Euclidean distance between vectors, thus providing results with clear geometric significance, and the MSE loss function's gradient computation is straightforward, thus aiding in the stable training of the model.

In action S280, the system updating the speech protection model 130 based on the loss function. In some implementations, the update process uses optimization algorithms, such as gradient descent. Specifically, the system calculates the gradients of the loss function with respect to the model parameters and adjusts the model parameters accordingly.

In some implementations, during each iteration, the system randomly selects a batch of training sample pairs from the training set. For example, each batch includes four sets of training sample pairs, each training sample pair consisting of a first speech 111 and a second speech 112 from different speakers. The system does not fix specific speaker combinations but randomly chooses different speaker pairings throughout the training process to enhance the model's generalization capability.

In some implementations, in the next iteration, the system randomly selects new speech sample pairs from the training set. For example, the system may choose four new pairs of speeches 110, each pair including a new first speech 111 and a new second speech 112. In some implementations, the system ensures that these new speech samples come from different speakers than those in the previous iteration to increase the diversity of the training data. This sample selection strategy continues throughout the training process until predefined stopping criteria are met, such as reaching a specific number of iterations or convergence of the loss function. Advantageously, this dynamic sample selection mechanism enhances the model's performance in handling different speaker combinations.

In other implementations, the system may employ more complex optimization strategies, such as adaptive learning rates or momentum techniques. For example, when the loss function decreases slowly, the system may automatically adjust the learning rate or use a momentum term to accelerate convergence. Advantageously, this optimization strategy combined with random sampling training methods effectively improves the model's generalization performance and training efficiency.

In some implementations, the system uses a cyclic learning rate strategy for model updates. For example, the system may use an optimizer (such as the Adam optimizer) and cycle the learning rate between a maximum of 0.001 and a minimum of 0.00001. Advantageously, this learning rate adjustment strategy helps the model converge more effectively to the optimal solution.

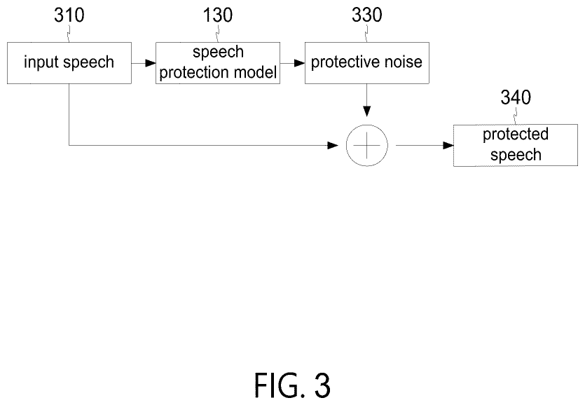

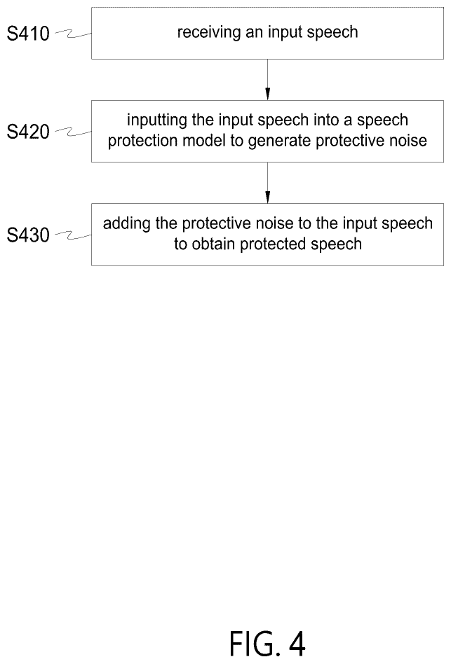

FIG. 3 is a diagram of a speech protection model in accordance with an example implementation of the present disclosure. FIG. 4 is a flowchart of a speech protection model in accordance with an example implementation of the present disclosure.

In addition to providing a method for training a speech protection model, the present disclosure also offers an implementation method for actual speech protection. Specifically, this method uses the speech protection model 130, trained through the actions S210 to S280, to protect input speech.

Specifically, when users wish to protect their speech from being stolen or forged by deepfake technologies, they may initially input the speech to be made public into the speech protection model 130, that is trained through the actions S210 to S280, for protection processing before public use.

In some implementations, the application scenarios for speech protection may cover various situations where speech security is needed. For example, before giving a public speech, a politician could have a speech recording processed by the speech protection model 130 of the present disclosure before uploading the speech recording to online platforms, in order to prevent his/her voice from being used by others, such as to create deepfake videos with false statements. Similarly, celebrities uploading audio files to social media may initially use the method of the present disclosure to protect their voice characteristics, thus reducing the risk of being exploited by others using voice conversion technologies for fraud. Advantageously, the speech protection method provided by the present disclosure not only effectively safeguards users' speech characteristics from being stolen by deepfake technologies but also maintains the naturalness and intelligibility of the speech. This allows users to protect their speech securely while still maintaining normal speech communication and usage needs.

Referring to FIG. 3 and FIG. 4, in action S410, the system receiving the input speech 310 that needs protection. In some implementations, the input speech 310 may be a live recording or a pre-stored audio file. Specifically, the system supports various common audio formats, such as WAV, MP3, etc., and the present disclosure is not limited thereto. Advantageously, this flexible input support allows the disclosure's protection method to be widely applied in various scenarios.

In action S420, the system inputting the input speech 310 into the trained speech protection model 130 to generate protective noise 330. In some implementations, the parameters of the speech protection model 130 are fixed, meaning that for the same input speech 310, the model may produce the same protective noise 330. In other implementations, the model may introduce randomness, such that each processing of even the same input speech 310 produces slightly different protective noise 330. Advantageously, this design adds unpredictability to the protection mechanism, thus further enhancing security.

In some implementations, the system performs feature extraction on the input speech 310 to obtain input speech features. Specifically, the system converts the input speech 310 into a Mel-spectrogram and extracts the input speech features from it. Simultaneously, the system selects a speech, from the speech database 310, that is from a speaker having a gender different from that of the input speech 310, as an auxiliary speech, converts this auxiliary speech into a Mel-spectrogram, and extracts features from the Mel-spectrogram. Then, the system inputs the input speech 310, input speech features, and auxiliary speech features into the speech protection model 130 to generate protective noise 330. It should be noted that the generation of protective noise 330 still involves the features of the auxiliary speech in the calculations, similar to the training phase, but actual application does not require iterative training with a large variety of speeches 110, as in the training phase. Moreover, the reason for choosing an auxiliary speech of a gender different from the input speech 310 is to help the speech protection model 130 generate more effective protective noise 330, thus allowing the speech features to effectively prevent the speech from being copied while maintaining the intelligibility of the input speech 310. Advantageously, this design ensures the consistency and reliability of the protection effect.

In some implementations, the system performs mean shifting on the generated protective noise 330. For example, the system calculates the average value of the protective noise 330 along the time axis and subtracts this average value from the protective noise 330 to make the mean of the protective noise zero. Advantageously, this mean shifting treatment increases the randomness of the protective noise, thus avoiding noise that is merely a simple shift of the original signal, thus enhancing the reliability of the protection effect.

In action S430, the system adding the protective noise 330 to the input speech 310 to obtain a protected speech 340. In some implementations, this addition process is performed directly in the time domain as a signal overlay. For example, the system adjusts the intensity of the protective noise 330 based on a predefined Signal-to-Noise Ratio (SNR), then adds the adjusted noise signal to the input speech 310 signal.

In some implementations, the method that is configured by the system to adjust the intensity of the protective noise 330 may be calculated as follows:

$${δ}_{x} = \frac{R M S ( x )}{R M S ( {δ}_{x} ) \cdot {10}^{\frac{z}{20}}} \cdot {δ}_{x}$$

where δₓ represents the protective noise 330, x represents the input speech 310, and z is a noise constraint parameter, for example, z may be set to 20. After the adjustment of the intensity of the protective noise 330 is completed, the system adds the adjusted protective noise 330 to the input speech 310 to produce the protected speech 340.

It should be noted that the speech protection method of the present disclosure has multiple advantages. In some implementations, since the noise is generated based on specific speech features, the noise may protect the speech from unauthorized replication while maintaining its intelligibility. Specifically, the protected speech remains clear and understandable to human listeners but difficult for speech conversion systems to extract effective features. In other implementations, the protection method of this disclosure has a lower computational complexity, making it suitable for real-time processing scenarios. Advantageously, these features enable the method of this disclosure to play a significant role in practical applications.

The method of the present disclosure may be applied in multiple practical scenarios. In some implementations, it may be used to protect voice messages, such as voice memos and voice calls. Specifically, the system may automatically add protective noise before the speech is stored or transmitted. In other implementations, it may be integrated into voice assistants or smart devices to provide protection in real-time when users speak. Advantageously, this real-time protection mechanism may effectively prevent speech from being illegally recorded and replicated.

For example, in financial industry applications, the method of the present disclosure is particularly suitable for voice banking services. When customers perform voice verification or give transaction instructions over the phone, the system may protect the customer's speech in real-time, preventing the voice from being recorded and used to impersonate the customer. Advantageously, this protection mechanism may effectively prevent voice-based fraud.

For example, in the news media industry, the method of the present disclosure may be used to protect the broadcast speech of news professionals. Specifically, the system may automatically add protective processing to the speech files of news releases before uploading them to public platforms, preventing others from using the anchor's voice to create fake news. Advantageously, this application may effectively maintain the authenticity of news and the credibility of the media.

For example, in professional conference settings, the method of the present disclosure may be applied to protect the speeches of participants. Specifically, the system may protect the speech in real-time during video conferences, thus preventing important statements from being extracted and used to make false statements.

In some implementations, to verify the advantages of the present disclosure over existing technologies, objective evaluations include metrics such as Attack Success Rate (ASR) and Preserve Success Rate (PSR). In a white-box scenario, the present disclosure achieved an ASR of 0.94 while maintaining a PSR of 0.82, a significant improvement over the existing technology's ASR of 0.53.I In a black-box scenario, the present disclosure still achieved an ASR of 0.85. Additionally, maintaining a high Signal-to-Noise Ratio (SNR) of 19.98, the present disclosure achieved a Perceptual Evaluation of Speech Quality (PESQ) score of 1.90 and a Short-Time Objective Intelligibility (STOI) of 0.81, thus demonstrating excellent speech quality protection capabilities and reliability.

In some implementations, subjective evaluations included human ear identification tests, the results of which showed that the present disclosure could effectively balance protection effects and speech quality. Specifically, the speech processed using the method of the present disclosure was clearly identifiable by the participants as retaining the original speaker's characteristics while effectively preventing speech conversion systems from copying the speaker's features. Advantageously, these experimental results validate the advantages of the present disclosure in protecting speech features and maintaining speech quality.

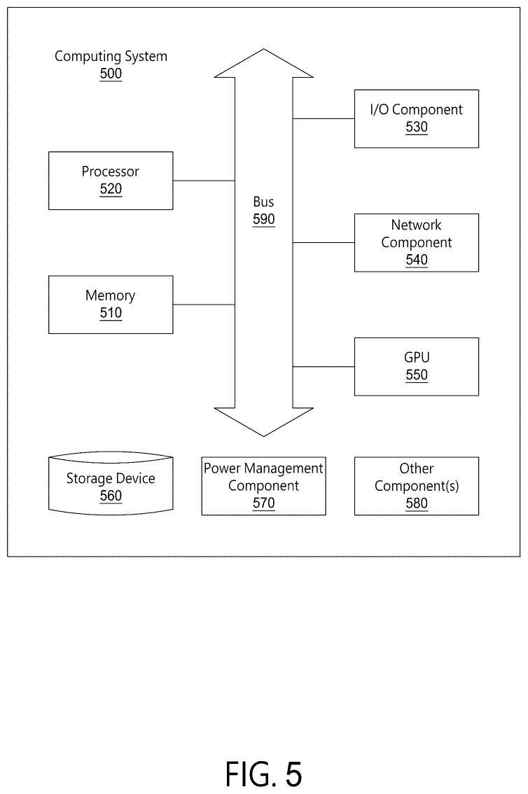

FIG. 5 is a block diagram a computing system in accordance with an example implementation of the present disclosure.

Referring to FIG. 5, computer-implemented methods, such as methods for training the speech protection model introduced in the present disclosure, as well as other computer-implemented methods, may be implemented on a computing system 500 with various hardware components. In some implementations, the computing system 500 may be implemented in the form of an electronic device, which may include, but is not limited to, one or more of the following components: processor (e.g., Central Processing Unit (CPU)) 520, Graphics Processing Unit (GPU) 550, input/output components 530, network components 540, and memory 510. These components may communicate and transfer data via a system bus 590. However, the present disclosure does not limit the specific models, quantities, and configurations of these components. Those skilled in the art can adjust, select, or add/subtract components based on the specific requirements and operating environment when implementation.

In some implementations, the primary computing core inside the computing system 500 is one or more processors 520. This processor 520 may be responsible for running the main computational processes and related control logic of algorithms, such as deep learning. In some implementations, the processor 520 may be configured to execute processing instructions (e.g., machine/computer-executable instructions) stored in non-volatile computer-readable media (e.g., storage device 560).

In some implementations, to enhance the computational efficiency of federated learning, the computing system 500 may also include one or more graphics processing unis 550 designed for massive parallel computations. The graphics processing unit 550 may effectively improve the system's computational capacity during deep learning training and inference.

In some implementations, the computing system 500 may include various input/output components 530 that are configured to receive user input and display system output. For example, the input/output components 530 may include a keyboard, mouse, touchpad, display screen, speakers, and other types of sensing devices.

In some implementations, the computing system 500 may also include network components 540 configured for network communication. For example, the network component 540 may include a network interface card for wired or wireless network connections, or communication modules for 3G, 4G, 5G, or other wireless communication technologies.

In some implementations, the computing system 500 may include one or more memory components 510, such as volatile memory components like Random Access Memory (RAM). The memory 510 may store the parameters of the deep learning model, as well as other data and programs that are used to run algorithms, such as deep learning.

Furthermore, the computing system 500 may also include one or more of the following components: storage devices 560, power management components 570, and other various hardware components 580.

In some implementations, the computing system 500 may include one or more storage devices 560, such as non-volatile memory components like Hard Disk Drive (HDD) or Solid-State Drive (SSD). The storage devices 560 may be configured to store the code of federated learning software, training data, model parameters, etc. Additionally, storage devices 560 may also be configured to store intermediate results and final outputs of algorithms, such as federated learning.

In some implementations, the computing system 500 may include one or more power management components 570, which are configured to provide power to various hardware components of the computing system 500 and manage their power consumption. This power management component 570 may include batteries, power converters, and other power management devices.

In some implementations, the computing system 500 may also include other various hardware components 580, such as cooling fans, heat dissipators, and other various control and monitoring devices. The present disclosure is not limited in this regard.

In summary, the speech protection model training method and system provided in the implementations of the present disclosure have the following technical advantages. First, unlike existing passive detection methods, the present disclosure implements an active speech protection mechanism through a loss function designed based on feature distances, thus enabling the speech protection model to effectively learn how to generate targeted protective noise. Second, unlike traditional methods that require feature extraction followed by speech synthesis in a two-stage process, the present disclosure adopts direct waveform generation, thus avoiding the problem of feature mismatch. Third, compared to existing technologies that cannot simultaneously consider protection effectiveness and speech intelligibility, the present disclosure achieves both effective protection against speech replication and maintains the naturalness and intelligibility of the speech through an improved WaveUNet architecture. Fourth, the real-time protection mechanism provided by the present disclosure overcomes the limitations of traditional passive detection methods, which may only detect already copied speech, thus enabling more effective prevention of illegal speech copying and theft.

Based on the above description, it is apparent that various techniques can be configured to implement the concepts described in this application without departing from their scope. Furthermore, although certain implementations have been specifically described and illustrated, those skilled in the art will recognize that variations and modifications can be made in form and detail without departing from the scope of the concepts. Thus, the described implementations are to be considered in all respects as illustrative and not restrictive. Moreover, it should be understood that this application is not limited to the specific implementations described above, but many rearrangements, modifications, and substitutions can be made within the scope of the present disclosure.

What is claimed is:

1. A method for training a speech protection model, applicable to a system comprising a speech database, the method comprising:
selecting a first speech and a second speech from the speech database;
extracting a plurality of first features from the first speech;
extracting a plurality of second features from the second speech;
generating a first mixed speech based on the first speech, the plurality of first features, and the plurality of second features using the speech protection model;
extracting a plurality of third features from the first mixed speech;
calculating a first distance between the plurality of third features and the plurality of first features and a second distance between the plurality of third features and the plurality of second features;
calculating a loss function based on the first distance and the second distance; and
updating the speech protection model based on the loss function, wherein:
the loss function is positively correlated with the first distance, and
the loss function is negatively correlated with the second distance.

2. The method of claim 1, wherein generating the first mixed speech based on the first speech, the plurality of first features, and the plurality of second features using the speech protection model comprises:
inputting the first speech, the plurality of first features, and the plurality of second features into the speech protection model to generate an initial noise; and
adding the initial noise to the first speech to obtain the first mixed speech.

3. The method of claim 2, wherein adding the initial noise to the first speech to obtain the first mixed speech comprises:
performing an offset removal operation on the initial noise to obtain an adjusted noise; and
adding the adjusted noise to the first speech based on a first signal-to-noise ratio to obtain the first mixed speech.

4. The method of claim 1, wherein the first speech and the second speech are from different speakers.

5. The method of claim 1, wherein the first speech is a time-domain signal, and extracting the plurality of first features from the first speech comprises:
converting the first speech into a Mel-spectrogram; and
extracting the plurality of first features from the Mel-spectrogram.

6. A computer-implemented method for speech protection, the method comprising:
receiving an input speech;
generating a protective noise based on the input speech and a speech protection model; and
adding the protective noise to the input speech to obtain a protected speech, wherein the speech protection model is trained by:
selecting a first speech and a second speech from a speech database;
extracting a plurality of first features from the first speech;
extracting a plurality of second features from the second speech;
generating a first mixed speech based on the first speech, the plurality of first features, and the plurality of second features using the speech protection model;
extracting a plurality of third features from the first mixed speech;
calculating a first distance between the plurality of third features and the plurality of first features and a second distance between the plurality of third features and the plurality of second features;
calculating a loss function based on the first distance and the second distance; and
updating the speech protection model based on the loss function, wherein:
the loss function is positively correlated with the first distance, and
the loss function is negatively correlated with the second distance.

7. The method of claim 6, wherein generating the first mixed speech based on the first speech, the plurality of first features, and the plurality of second features using the speech protection model comprises:
inputting the first speech, the plurality of first features, and the plurality of second features into the speech protection model to generate an initial noise; and
adding the initial noise to the first speech to obtain the first mixed speech.

8. The method of claim 7, wherein adding the initial noise to the first speech to obtain the first mixed speech comprises:
performing an offset removal operation on the initial noise to obtain an adjusted noise; and
adding the adjusted noise to the first speech based on a first signal-to-noise ratio to obtain the first mixed speech.

9. The method of claim 6, wherein the first speech is a time-domain signal, and extracting the plurality of first features from the first speech comprises:
converting the first speech into a Mel-spectrogram; and
extracting the plurality of first features from the Mel-spectrogram.

10. A speech protection system, comprising:
an input component configured to receive an input speech;
a memory configured to store at least one instruction; and
a processor coupled to the input component and the memory, wherein when the processor executes the at least one instruction, the processor is configured to:
generate a protective noise based on the input speech and a speech protection model; and
adding the protective noise to the input speech to obtain a protected speech, wherein the speech protection model is trained by:
selecting a first speech and a second speech from a speech database;
extracting a plurality of first features from the first speech;
extracting a plurality of second features from the second speech;
generating a first mixed speech based on the first speech, the plurality of first features, and the plurality of second features using the speech protection model;
extracting a plurality of third features from the first mixed speech;
calculating a first distance between the plurality of third features and the plurality of first features and a second distance between the plurality of third features and the plurality of second features;
calculating a loss function based on the first distance and the second distance; and
updating the speech protection model based on the loss function, wherein:
the loss function is positively correlated with the first distance, and
the loss function is negatively correlated with the second distance.
